(19) United States
(12) Patent Application Publication
(10) Pub. No.: US 2018/0060865 A1
(43) Pub. Date: Mar. 1, 2018

(54) RETRIEVING PAYMENT INFORMATION FOR A USER FROM AN AUTHENTICATION SERVER FOR USE IN PURCHASE REQUESTS TO VENDORS

(71) Applicant: VenueNext, Inc., Santa Clara, CA (US)

(72) Inventors: Chester Dean, Brooklyn, NY (US); John M. Paul, Palo Alto, CA (US)

(21) Appl. No.: 15/244,877

(22) Filed: Aug. 23, 2016

(51) Int. Cl. G06Q 20/40; H04L 29/06

(52) U.S. Cl. CPC G06Q 20/4014; G06Q 2220/00; H04L 67/42

(57) ABSTRACT

A payment system receives a purchase request from a client device identifying products or services from a vendor. An authentication server stories payment information in association with various device identifiers. The payment system obtains a device identifier associated with the client device and transmits a request to the authentication server, which determines whether payment information associated with the device identifier is stored. If the authentication server stores payment information associated with the device identifier, the authentication sever transmits a confirmation to the payment system. The payment system sends a payment confirmation to a vendor system associated with the vendor in response to receiving the confirmation. Additionally, the payment system sends a purchase confirmation to the client device in response to receiving the confirmation.

### BACKGROUND

This invention relates generally to a payment system associated with a venue, and more specifically to a payment system various purchases may be made without entering payment.

Venues such as stadiums, convention centers, theme parks, or amphitheaters frequently host events attended by large numbers of users. These users compensate the venue in exchange for attending the venue during an event, providing revenue to the venue. Many venues also obtain additional revenue from vendors associated with the venue that provide goods or services to users attending the venue or from selling parking spaces in one or more parking lots associated with the venue to users attending the venue.

However, if a large number of users attend a venue, congestion may impair many users' experience purchasing goods or services at the venue. For example, delays in placing orders with vendors or delays in vendors fulfilling received orders may discourage users from purchasing goods or services from vendors associated with the venue, decreasing revenue to the vendor, which also decreases revenue to the venue. Some vendors and service providers may allow a user to pre-purchase goods or services via an application associated with the vendor and executing on a client device for convenience. However, users often need to provide payment information to applications associated with different vendors executing on the client device or for each transaction between a vendor and the user. Providing payment information to multiple applications or for multiple transactions may inconvenience many users and increase time for vendors to process payments. This may subsequently reduce the amount of purchases made by users, decreasing revenue to the venue.

### SUMMARY

A venue is a geographic location, such as a geographic location associated with one or more structures. Examples of a venue include a stadium, a convention center, an arena, a theater, an amphitheater, a theme park, or other suitable structure or location where people may gather for an event. In various embodiments, users obtain a ticket to enter the venue, and various events are performed at the venue. Additionally, one or more vendors are associated with the venue and provide goods or services to users attending the venue. Examples of vendors include restaurants, food service providers, beverage providers, merchandise retailers, or other suitable entities providing products or services. Each vendor uses one or more terminals to identify products or services purchased by a user. Based on information provided by a user to the vendor through a terminal or a client device, the vendor retrieves or produces a product or service to the user. For example, through an application associated with a vendor and executing on a client device, the vendor receives information identifying a product or a service provided by the vendor and the vendor retrieves or produces the identified product or service. The user also receives payment information for the identified product or service from the user, and the vendor uses the payment information to obtain compensation from the user in exchange for the product or service.

To improve user interaction with the venue, a payment system enables a user to make payments to one or more vendors without entering payment information for each transaction. In various embodiments, an authorization server stores payment information in association with various device identifiers and receives requests to identify payment information associated with various device identifiers from the payment system. Users provide payment information to the authorization server via one or more client devices or via the payment system, and the authorization server stores payment information received from a client device in association with a device identifier of the client device or stores payment information received from the payment system in association with a device identifier of a client device corresponding to the payment information. For example, the device identifier of a client device is a phone number, so the authorization server stores payment information in association with a phone number of a client device from which the payment information was received. Alternatively, the device identifier is a universal unique identifier (UUID) generated by an application associated with a vendor or by an application associated with the payment system and executing on the client device. For example, the application associated with the payment system generates a 128-bit value uniquely identifying the client device when the application is initially installed on the client device and stores the 128-bit value on the client device. Via an application associated with a vendor or associated with the payment system executing on a client device, a user identifies products or services provided by the vendor and communicates a purchase request for the identified products or services to the payment system. When the payment system receives the purchase request identifying the products or services, the payment system obtains a device identifier corresponding to the client device from which the purchase request was receive or otherwise associated with the user and sends a request to the authorization server to search for payment information associated with the device identifier. In various embodiments, the device identifier is a universal unique identifier (UUID) generated when the application associated with the vendor or the application associated with the payment system is installed on the client device. The UUID may be stored on the client device and subsequently obtained by the payment system or included in the purchase request. The request sent to the authorization server includes the device identifier and information identifying the purchase request including the vendor and the products or services identified by the user.

The authorization server compares the device identifier to stored devices identifiers maintained by authorization server. In response to determining the device identifier matches a stored device identifier, the authorization server authenticates payment information associated with the stored device identifier matching the device identifier. In some embodiments, payment information stored by the authentication server has previously been authenticated. Alternatively, the authorization server requests authorization of stored payment information by a financial institution or other associated with the stored payment information. For example, a financial institution corresponding to stored payment information verifies funds in an account associated with the payment information or verifies an account is associated with the stored payment information. In response to authenticating the payment information, the authentication server communicates a confirmation to the payment system. After receiving the confirmation from the authentication server, the payment system communicates a payment confirmation to the client device and communicates a payment confirmation to the client device and to a vendor system associated with a vendor providing the products or services identified by the purchase request.

However, in response to determining the device identifier does not matches a stored device identifier, the authentication server transmits a notification message to the client device prompting the user to provide payment information to the authentication server. Alternatively, the authentication server transmits an indication that authenticated payment information associated with the device identifier is not stored to the payment system, which transmits the notification message to the client device prompting the user to provide payment information to the authentication server. For example, if the authorization server has not previously stored payment information associated with the device identifier, the authorization server transmits a form to the client device prompting a user to provide credit card information or other payment information when presented by the client device. The authorization server stores payment information received from the client device via the form in association with the device identifier. Hence, the payment system does not store payment information for various users and does not have access to payment information associated with various device identifiers, but obtains a confirmation from the authorization server that maintains payment information in association with various device identifiers. Communication between the payment system and the authorization server allows a user at a venue to more easily purchase goods or services from various vendors by leveraging stored payment information maintained by the authorization server that allows a user to purchase goods or services without entering payment information.

### BRIEF DESCRIPTION OF THE DRAWINGS

FIG. 1 is a block diagram of a venue, in accordance with an embodiment.

FIG. 2 is a block diagram of a system environment including a payment system, in accordance with an embodiment.

FIG. 3 is a block diagram of functional components of the payment system, in accordance with an embodiment.

FIG. 4 is an interaction diagram of a method for obtaining payment information for a purchase request identifying products or services to provide to a user, in accordance with an embodiment.

The figures depict various embodiments for purposes of illustration only. One skilled in the art will readily recognize from the following discussion that alternative embodiments of the structures and methods illustrated herein may be employed without departing from the principles of described herein.

### DETAILED DESCRIPTION

### Venue Overview

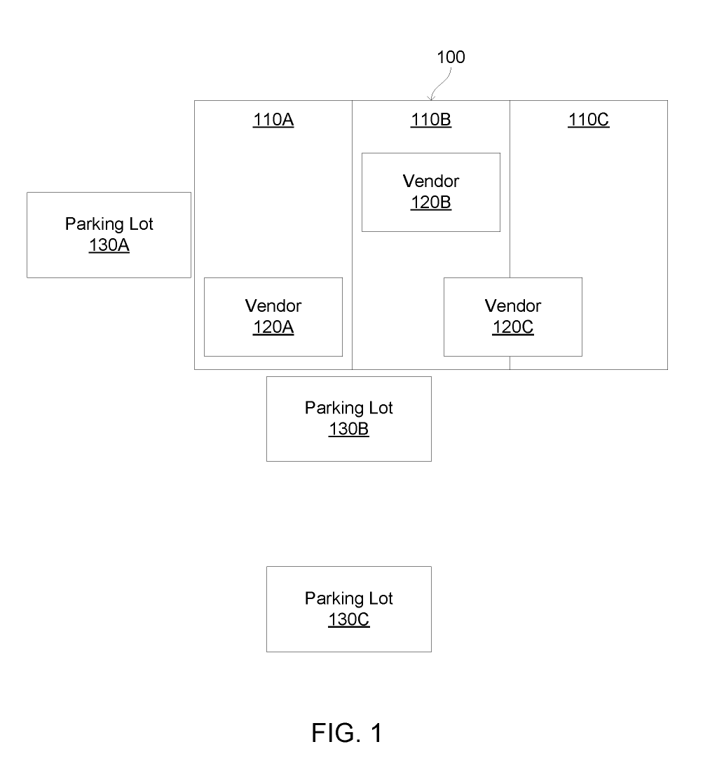

FIG. 1 is a block diagram of one embodiment of a venue 100. In the example of FIG. 1, the venue includes multiple regions 110A, 110B, 110C (also referred to individually and collectively using reference number 110). Additionally, one or more vendors 120A, 120B, 120C (also referred to individually and collectively using reference number 120) are included in the venue 100, and one or more parking lots 130A, 130B, 130C (also referred to individually and collectively using reference number 130) are associated with the venue 100. However, in other embodiments, different and/or additional components may be associated with or included in the venue 100.

The venue 100 is a geographic location, such as a geographic location associated with one or more structures. Examples of a venue 100 include a stadium, a convention center, an arena, a theater, an amphitheater, or other suitable structure. One or more regions 110 are included in the venue 100, with each region 110 corresponding to an area within the venue 100. For example, different regions 110 correspond to different sections of a stadium, different aisles of a stadium or arena, different rooms in a convention center, or any other suitable area within the venue 100. In some embodiments, an area within the venue 100 is associated with multiple regions 110 having different levels of precision. For example, a specific seat in a venue 100 is associated with a region 110 identifying a section including the seat, another region 110 identifying an aisle within the section including the seat, and an additional region identifying the specific seat. While FIG. 1 shows an example venue 100 including three regions 110A, 110B, 110C, in other embodiments, a venue 110 may include any number of regions 110.

One or more vendors 120 are included in the venue 110, with each vendor providing products or services to users within the venue 110. Examples of vendors 120 include restaurants, food service providers, beverage providers, merchandise retailers, or other suitable entities providing products or services. Different vendors 120 may be associated with different regions 110 of the venue. For example, a vendor 120A is associated with a region 110A, while a different vendor 120B is associated with a different region 110B. A vendor 110 may be associated with multiple regions 110; for example, a vendor 120C is associated with a region 110B as well as with an additional region 110C. In some embodiments, a vendor 120 is associated with a region 110 based on a distance between the vendor 120 and the region 110. For example, the vendor 120 is associated with a region 110 having a minimum distance from a location associated with the vendor 120. If a location associated with a vendor 120 is within a region 110, the vendor 120 is associated with the region 110 including the vendor's associated location.

Additionally, one or more parking lots 130A, 130B, 130C are associated with the venue 110 and identify physical locations for parking vehicles. Each parking lot includes one or more spaces, each space for parking a vehicle. A price is associated with each parking lot 130 specifying an amount of compensation a user provides to an entity associated with the venue 110 for a space in the parking lot 130 to be allocated for parking a vehicle associated with the user. Different parking lots 130 may have different distances from the venue 110, and prices associated with different parking lots 130 may be inversely proportional to a distance between a parking lot 130 and the venue 110. Each parking lot 130 is also associated with a capacity specifying a maximum number of vehicles that may be parked in a parking lot 130. The capacity may be a total number of spaces in the parking lot 130 or may be a maximum number of vehicles. Information may be maintained by one or more devices included in a parking lot 130 specifying a number of spaces in the parking lot 130 in which vehicles are parked, specifying a number of vehicles within a geographic area associated with the parking lot 130, or any other suitable information. For example, a device included in the parking lot 130 increments a counter when a vehicle enters the geographic area associated with the parking lot 130 or when a vehicle is parked in a space of the parking lot 130.

### System Architecture

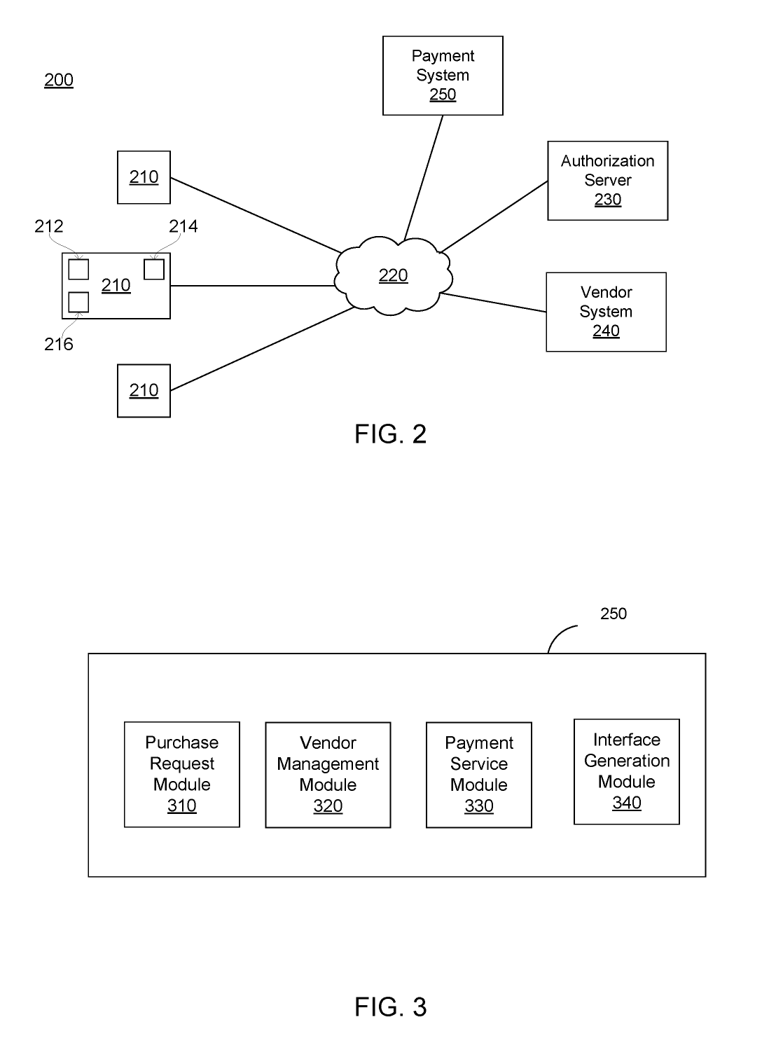

FIG. 2 is a block diagram of a system environment including a payment system, in accordance with an embodiment. The system environment 200 shown by FIG. 1 includes various client devices 210, a network 220, a payment gateway 230, a vendor system 240, and a payment system 250. In alternative configurations, different and/or additional components may be included in the system environment 200. The embodiments described herein may be adapted to any system allowing an order to purchase goods or services from one or more vendors.

A client device 210 is one or more computing devices capable of receiving user input as well as transmitting and/or receiving data via the network 220. In one embodiment, the client device 210 is a conventional computer system, such as a desktop computer or a laptop computer. Alternatively, the client device 210 may be a device having computer functionality, such as a personal digital assistant (PDA), a mobile telephone, a smartphone, a smartwatch, or another suitable device. A client device 210 is configured to communicate with other devices via the network 220. In one embodiment, the client device 210 executes an application allowing a user of the client device 210 to interact with the payment system 250. For example, the client device 210 executes a browser application to enable interaction with the payment system 250 or with one or more vendor systems 240 via the network 220. In another embodiment, a client device 210 interacts with the payment system 250 through an application programming interface (API) running on a native operating system of the client device 210, such as IOS® or ANDROID™

A display device 212 included in a client device 210 presents content items to a user of the client device 210. Examples of the display device 212 include a liquid crystal display (LCD), an organic light emitting diode (OLED) display, an active matrix liquid crystal display (AMLCD), or any other suitable device. Different client devices 210 may have display devices 212 with different characteristics. For example, different client devices 212 have display devices 212 with different display areas, different resolutions, or differences in other characteristics.

One or more input devices 214 included in a client device 210 receive input from the user. Different input devices 214 may be included in the client device 210. For example, the client device 210 includes a touch-sensitive display for receiving input data, commands, or information from a user. Using a touch-sensitive display allows the client device 210 to combine the display device 212 and an input device 214, simplifying user interaction with presented content items. In other embodiments, the client device 210 may include a keyboard, a trackpad, a mouse, or any other device capable of receiving input from a user. Additionally, the client device may include multiple input devices 214 in some embodiments. Inputs received via the input device 214 may be processed by an application associated with the payment system 250 and executing on the client device 210 to allow a client device user to exchange information with the payment system 250.

Additionally, a client device 210 may include one or more position sensors 216, which determine a physical location associated with the client device 210. For example, a position sensor 216 is a global positioning system (GPS) sensor that determines a location associated with the client device 210 based on information obtained from GPS satellites communicating with the GPS sensor, such as coordinates specifying a latitude and longitude of the location associated with the client device 210. As another example, a position sensor 216 determines a location associated with the client device 210 based on intensities of signals received from one or more access points (e.g., wireless access points) by the client device 110. In the preceding example, the position sensor 216 determines a location associated with the client device 210 based on signal intensity between the client device 210 and one or more wireless access points and service set identifiers (SSIDs) or media access control (MAC) addresses of the wireless access points. However, the client device 210 may include any suitable type of position sensor 216. In various embodiments, the client device 210 may include multiple position sensors 216.

The network 220 may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

An authorization server 230 maintains payment information associated with various device identifiers and authenticates maintained payment information. In some embodiments, the authentication server 230 stores payment information that has been authenticated in association with a device identifier of a client device 210 from which the payment information was received or in association with a device identifier of a client device 210 otherwise associated with the payment information. The authentication server 230 may encrypt or otherwise obfuscate the payment information and store the encrypted of obfuscated payment information in association with device identifiers. In some embodiments, the authentication server 230 stores the device identifiers and associated payment information in an external system and communicates with the external system to identify stored payment information associated with a device identifier. Alternatively, the authentication server 230 internally stores the device identifiers and payment information associated with various device identifiers. For example, the authentication server 230 maintains a database including payment information and device identifiers of client devices 210 associated with the payment information. In some embodiments, payment information maintained by the authorization server 230 is not stored until it has been authenticated from a financial institution or other entity providing compensation based on the payment information. Alternatively, the authorization server 230 maintains payment information associated with a device identifier of a client device 210 and communicates with a financial institution or other entity to authentication the payment information when the authorization server 230 retrieves the payment information.

To simplify a user purchasing goods or services, such as goods or services provided by a vendor 120 associated with a venue 100, the authentication server 230 receives a device identifier from the payment system 250 or from a vendor system 240 identified by a request to authenticate payment information associated with the device identifier. The authentication server 230 determines wither the authentication server 230 includes stored payment information associated with the device identifier identified by the request. In response to determining the authentication server 230 includes stored payment information associated with the device identifier, the authentication server 230 authenticates the stored payment information associated with the device identifier. If the authentication server 230 stores authenticated payment information, the payment information associated with the device identifier identified by the request is authenticated when it is identified. However, if the authentication server 230 does not authenticate payment information prior to storing the payment information in association with the device identifier, after identifying stored payment information associated with the device identifier identified by the request, the authentication server 230 communicates with a financial institution or other entity to authenticate the stored payment information associated with the device identifier identified by the request. In response to authenticating stored payment information associated with the device identifier identified by the request, the authentication server communicates a payment confirmation notification to the payment system 250 or to the vendor system 240.

However, if the authentication server 230 does not include stored payment information associated with the device identifier identified by the request or if the authentication server 230 is unable to authenticate stored payment information associated with the device identifier identified by the request, the authentication server 230 sends a request for payment information to the client device 210 associated with the device identifier identified by the request. For example, the authentication server 230 communicates a form for entering credit card details or other account information to the client device 210 associated with the device identifier identified by the request. A user of the client device 210 provides the payment information to the authentication server 230 by interacting with the notification via the client device 210, which sends the payment information to the authentication server 230 in association with a device identifier of the client device 210. After receiving the payment information in association with the device identifier, the payment gateway 230 authenticates the payment information and stores the payment information in association with the device identifier of the client device 210. Alternatively, the authentication server 230 stores the payment information in association with the device identifier and later authenticates the payment information. If the payment information received from the client device 210 is authenticated by the authentication server 230, the authentication server 230 sends a payment confirmation notification to the payment system 250 or to the vendor system 240. In some embodiments, the authentication server 230 receives vendor information associated with the device identifier and the payment information. For example, the vendor information is a vendor identifier specifying a vendor 120 for which the payment information associated with the device identifier is used, allowing the authentication server 230 to also identify different payment information for use with different vendors 120. The authentication server 230 stores the vendor information in association with the device identifier and with the payment information, allowing subsequent use of the payment information associated with the device identifier when purchasing products or services from a vendor 120. For example, the request received by the authentication server 230 includes a device identifier and vendor information, and the authentication serve 230 retrieves stored payment information associated with the device identifier and with the vendor information.

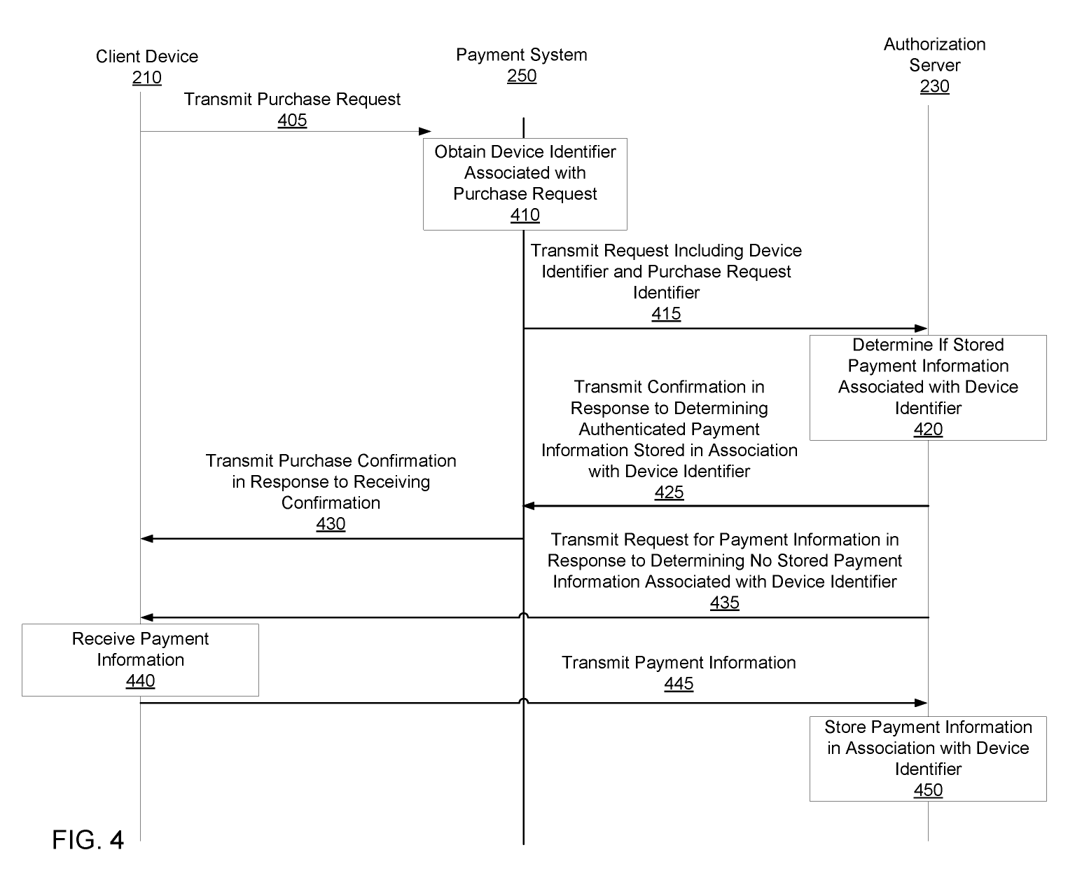

A vendor system 240 is associated with a vendor 120 and receives orders for products or services from the payment system 250 and provides the products or services identified by the orders. Further, a vendor system 240 may provide information to the payment system 250 describing products or services sold by a vendor 120 associated with the vendor system 240 and the price associated with the products. For example, the vendor system 240 identifies a number of different products or services sold by the vendor 120 or identifies an amount of revenue received by the vendor 120 in exchange for different products or services. The vendor system 240 may receive a request to purchase a product or a service (a “purchase request”) from a client device 210 associated with a user and communicate a request to search for payment information associated with a device identifier of the client device 210 to obtain payment for the product or the service, as further described below in conjunction with FIG. 4. The vendor system 240 provides the product or the service to the user associated with the client device 210 in response to receiving a payment confirmation from the payment system 250 of from the authentication server 230.

Additionally, a vendor system 240 provides the payment system 250 with information describing fulfilment of orders by a vendor 120 associated with the vendor system 240. For example, the vendor system 240 provides information to the payment system 250 specifying an estimated time to fulfill subsequently received or pending orders for products or services, an average time in which previously received orders were fulfilled, a number of unfulfilled orders received by the vendor system 240, or other suitable information. Information provided from the vendor system 240 to the payment system 250 accounts for orders received via the payment system 250 as well as orders received by the vendor 120 associated with the vendor system 240 from users visiting a location associated with the vendor 120.

A payment system 250 receives purchase requests for goods or services at a venue 100 and communicates with the authentication server 230 and with one or more vendor systems 240 to fulfill the purchase requests. For example, the payment system 250 receives a purchase request including a device identifier of a client device 210 associated with a user, a description of products or services, and information identifying a vendor 120 to provide the products or services. The payment system 250 communicates a request to search for payment information associated with the device identifier in the purchase request to the authentication server 230. In some embodiments, the payment system 250 receives a payment confirmation from the authentication server 230 in response to the authentication server 230 authenticating stored payment information associated with the device identifier and communicates a request for the products or services identified by the purchase request to the vendor system 240 associated with the vendor corresponding to the purchase request in response to receiving the payment confirmation. Alternatively, the payment system 250 communicates the request to search for payment information associated with the device identifier included in the purchase request to the authentication server 230 and sends a request for the products or the services to the vendor system 240 corresponding to the vendor information in the purchase request. The authentication sever 230 sends the payment confirmation to the vendor system 240 in response to authenticating stored information associated with the device identifier included in the purchase request. Based on the payment confirmation, the vendor system 240 provides the products or services identified by the purchase request.

FIG. 3 is a block diagram of one embodiment of an architecture of a payment system 250. In the example of FIG. 3, the payment system 250 includes a purchase request module 310, a vendor management module 320, a payment service module 330 and an interface generation module 340. However, in other embodiments, the payment system 250 may include different or additional components than those described in conjunction with FIG. 3.

The purchase request module 310 receives purchase requests for products or services provided by one or more vendors 120 associated with a venue 100. A vendor 120 provides information identifying products or services provided by the vendor 120 to the purchase request module 310, allowing the purchase request module 310 to maintain information identifying products or services provided by the vendor 120. Additionally, the purchase request module 310 receives purchase requests from client devices 210 identifying a vendor 120 and products or services provided by the vendor 120 that a user associated with the client device 210 seeks to purchase. For example, a vendor 120 associated with a venue 100 offers tickets for users to attend various events at the venue 100 and provides the purchase request module 310 with information identifying prices, dates, times, quantity of tickets available, and descriptive information for various events at the venue 100. The purchase request module 310 presents information describing products or services offered by a vendor 120 to a user via an application associated with the payment system 250 and executing on a client device 210 associated with the user. By interacting with the application via the client device 210, the user selects one or more products or services from the vendor. The application executing on the client device 210 generates a purchase request including a device identifier of the client device 210, information identifying the vendor 120, and information identifying products or services for purchase by the user. The client device 210 communicates the generated purchase request to the purchase request module 310. In some embodiments, the purchase request includes information identifying a profile of the user maintained by the payment system 250 and including information associated with the user, including one or more device identifiers of client devices 210 associated with the user. So the purchase request module 310 retrieves the device identifier from the profile associated with the user and identified by the purchase request. Alternatively, the purchase request module 310 obtains the device identifier from the client device 210 after receiving the purchase request from the client device 210. Referring to the preceding example, via the application associated with the payment system 250, a user communicates a purchase request for a ticket to attend a football game on a specific date at the venue 100. The purchase request module 310 does not request for the payment information (e.g., credit card information, debit card information) from the client device 210. In addition to the device identifier, the purchase request module 310 sends the transaction information such as the amount of purchase, the vendor information, the requested goods/service information and other such transaction information.

The vendor management module 320 receives orders for products or services from client devices 210 associated with users and communicates the orders to one or more vendor systems 240 of vendors 120 associated with the venue 100. In various embodiments, the vendor management module 320 includes vendor profiles each associated with one or more vendors 120 associated with the venue 100. A vendor profile includes a vendor identifier uniquely identifying a vendor 120 and additional information associated with the vendor 120, such as one or more regions 110 of the venue 100 associated with the vendor 120 and information for communicating with a vendor system 240 associated with the vendor 120. Further examples of information associated with the vendor 120 and included in a vendor profile include: contact information, hours of operation, a listing of products or services provided by the vendor 120, a current inventory or products maintained by the vendor 120, and a current time for the vendor 120 to fulfill received orders. However, in other embodiments, additional or different information may be included in the vendor profile. In one embodiment, the vendor management module 320 communicates with the authentication server 230 to request authentication of payment information associated with a device identifier of a client device 210 included in a purchase request received by the purchase request module 310.

When the vendor management module 310 receives a purchase request identifying a product or service and identifying a vendor 120, the vendor management module 310 communicates the order to a vendor system 240 corresponding to the identified vendor 120. The vendor 120 may subsequently deliver the product or service identified by the order to the user or may communicate a notification to the user via the payment system 250 when the order is fulfilled. To expedite delivery of products or services, the vendor management module 320 may associate different vendors 120 with different regions 110 of the venue 100 to reduce time for users to receive products or services delivered by vendors 120.

Additionally, the vendor management module 320 receives information from a vendor system 240 and communicates the information to one or more client devices 210 for presentation to users. For example, the vendor 120 communicates a payment confirmation, a time to fulfill an order, an estimated time to fulfill an order, a number of previously received orders that have yet to be fulfilled, or other suitable information to the vendor management module 310, which provides at least a subset of the information to a client device 210 for presentation to a user. As another example, a vendor system 240 communicates a message to the venue management module 310 including a user identifier, a purchase request identifier (or a description of goods or services requested by a user), and an indication that the purchase request corresponding to the purchase request identifier has been fulfilled by a vendor. The vendor management module 320 may identify a user corresponding to the user identifier from profiles maintained by the payment system 250 and including information associated with various users and communicates the message to a client device 210 associated with the user and identified by a device identifier included in the profile corresponding to the user identifier.

The payment service module 330 transmits sends requests to authenticate payment information included in a purchase request to the authorization server 230. A request sent by the payment service module 330 to the authorization server 230 includes a device identifier included in a purchase request and an identifier of the purchase request. In response to receiving a confirmation from the authentication server 230 that the authorization server 230 includes authorized payment information associated with the device identifier, the payment service module 330 communicates an indication to complete the purchase request to the vendor management module 320 to complete the purchase request; the vendor management module 320 communicates a payment confirmation to the vendor 120 associated with the purchase request so the vendor 120 fulfills the purchase request and may send a purchase completion receipt to the client device 210 from which the purchase request was received.

However, if the payment service module 330 does not receive a confirmation from the authorization server 230, the payment service module 330 sends a request to the interface generation module 340, which communicates a notification to a client device 210 from which a purchase request including a device identifier that is not associated with payment information by the authentication server 230. For example, the payment service module 330 requests a form requesting payment information from the interface generation module 340, and the interface generation module 340 transmits the form to a client device 210 for presentation. If the client device 210 receives payment information via the form, the client device 210 communicates the received payment information and a device identifier of the client device 210 to the interface generation module 340, which communicates the payment information and the device identifier to the authentication server 230 for storage.

FIG. 4 is an interaction diagram of one embodiment of a method for obtaining payment information for a purchase request identifying products or services to provide to a user. In other embodiments, the method may include different or additional steps than those described in conjunction with FIG. 4. Additionally, in other embodiments, steps of the method may be performed in orders different than the order described in conjunction with FIG. 4.

A payment system 250 obtains information describing products or services provided by a vendor 120 associated with a venue from a vendor system 240 associated with the vendor 120. Through an application associated with the payment system 250 and executing on a client device 210 of a user, the payment system 250 identifies products or services provided by the user and allows the user to select products or services for purchase from the vendor 120. For example, the application associated with the payment system 250 presents a listing of products or services (e.g., tickets, food items, beverages, clothing, etc.) offered by a vendor 120 and receives a selection of one or more products or services via user interaction with the application. The application executing on the client device 210 generates a purchase request identifying the selected products or services, the vendor 120 from which the products or services were requested, and a purchase request identifier. In some embodiments, the purchase request also includes a user identifier associated with the user by the payment system 250 or a device identifier (e.g., a phone number associated with the client device 210, a mobile device identification number of the client device 210, a mobile equipment identifier of the client device 210, an electronic serial number of the client device 210, an international mobile station equipment identity of the client device 210, an identifier generated by an application associated with the payment system 250 installed on the client device 210, or any other information capable of identifying the client device 210). In some embodiments, the device identifier is an identifier uniquely identifying the client device 210 (e.g., a universally unique identifier) generated by an application associated with the payment system 250 and executing on the client device 210 and stored on the client device 120. For example, the application associated with the payment system 250 generates a 128-bit value uniquely identifying the client device when the application is initially installed on the client device and stores the 128-bit value on the client device 210.

The client device 210 transmits 405 the purchase request to the payment system 250, which obtains 410 the device identifier associated with the purchase request. In some embodiments, the payment system 250 extracts the device identifier rom the received purchase request. Alternatively, the client device 210 requests the device identifier from the client device 210 in response to receiving the purchase request. In other embodiments, the payment system 250 retrieves a profile associated with a user identifier included in the purchase request and obtains 410 the device identifier from the retrieved user profile. For example, the application associated with the payment system 250 and executing on the client device 210 transmits the identifier generated by the application to the payment system 250 in association with a user identifier. The payment system 250 stores the identifier generated by the application in a profile associated with the user identifier to simplify subsequent retrieval of the identifier from the profile.

To obtain payment for the products or services identified by the purchase request, the payment system 250 transmits 415 a request including the device identifier to an authentication server 230 that stores payment information in association with device identifiers. The request includes the device identifier and an identifier of the purchase request. In some embodiments, the request also includes a purchase amount for the products or services identified by the purchase request. Additionally, the request may include information identifying a vendor 120 from which the products or services are requested. However, the request does not include the payment information or information from which the payment information is capable of being determined.

The authentication server 230 determines 420 whether a stored device identifier matches the device identifier included in the request. If the request includes information identifying the vendor 120, the authentication server 230 determines 420 whether the authentication server 230 stores payment information associated with both the device identifier included in the request and associated with information identifying the vendor 120. This allows specific payment information to be used for the identified vendor 120. If authentication server 230 does not store payment information associated with both the device identifier included in the request and associated with information identifying the vendor 120, the authentication server 230 determines 420 whether the authentication server 230 stores payment information associated with the device identifier. In response to determining 420 a stored device identifier matches the device identifier included in the request, the authentication server 230 determines whether payment information associated with the stored device identifier is authenticated. In some embodiments, the authentication server 230 authenticates the payment information before it is stored in associated with the stored device identifier, so the payment information is authenticated when the authentication server 230 determines 420 the stored device identifier matches the device identifier from the purchase request. Alternatively, the authentication server 230 communicates the payment information associated with the stored device identifier to a financial institution or other entity for authentication, and receives information indicating whether the payment information is authenticated or is not authenticated from the financial institution. When authenticating the stored payment information, the authentication sever 230 may determine whether an account associated with the stored payment information has funds equaling or exceeding a purchase amount included in the purchase request; if the account associated with the stored payment information has funds that are less than the purchase amount, the authentication server 230 does not authenticate the stored payment information. In response to determining the authorization server 230 includes stored payment information associated with the stored device identifier matching the device identifier included in the purchase request, the authorization server 230 transmits 425 a confirmation to the payment system 250 and charges the account associated with the stored payment information the purchase amount. The payment system 250 transmits 430 a purchase confirmation to the client device 210 in response to receiving the confirmation from the authentication server 230 and transmits a payment confirmation and the purchase request to a vendor system 240 associated with the vendor 120 providing the products or services identified by the purchase request. In various embodiments, the purchase confirmation is a receipt identifying the selected products or services and the purchase amount charged to the stored payment information maintained by the authentication server 230.

However, if the authentication server 230 determines 420 the authentication server 230 does not include stored payment information associated with the device identifier or if stored payment information associated with the device identifier is not authenticated, the authentication server 230 transmits 435 a request for payment information to the client device 210. For example, the authentication server 230 transmits a form prompting the user to provide payment information to the client device 210 for presentation. The form may include instructions that, when executed by the client device 210, encrypt information provided to the form.

The client device 210 receives 440 payment information via the form and transmits 445 the received payment information to the authentication server 230 in association with the device identifier associated with the client device 210. When the authentication server 230 receives the payment information, the authentication server 230 stores 450 the payment information in association with the device identifier of the client device 210. In various embodiments, the authentication server 230 encrypts (or otherwise obfuscates) payment information received from the client device 210 and stores 450 the encrypted payment information in association with the device identifier, allowing subsequent retrieval and use of the payment information while increasing security of the stored payment information.

Alternatively, the authentication server 230 transmits a notification to the payment system 250 in response to determining the authentication server 230 does not include stored payment information associated with the device identifier or if stored payment information associated with the device identifier is not authenticated. The payment system 250 transmits a request for payment information to the client device 210 in response to receiving the notification from the authentication server 230. For example, the payment system 250 generates a form requesting payment information and including one or more instructions that transmit payment information received via the form to the authentication server 230 and transmits the form to the client device 210. Alternatively, the form includes one or more instructions that, when executed by the client device 210 presenting the form encrypt payment information received via the form. The client device 210 transmits the encrypted payment information to the payment system 250 in association with the device identifier of the client device 210, and the payment system 250 transmits the encrypted payment information in association with the device identifier to the authentication system 230, which stores the encrypted payment information in association with the device identifier. In some embodiments, the form presented by the client device 210 receives information identifying a vendor 120 as well as the payment information, allowing the user to specify payment information for use with a particular vendor 120. If information identifying a vendor 120 is provided along with the payment information, the information identifying the vendor 120 is communicated to the authentication server 230 as well as the payment information and the device identifier. The authentication server 230 stores the payment information in association with the device identifier and the information identifying the vendor 120.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, from an application executing on a client device, a purchase request to purchase a product or a service from a provider;
obtaining a device identifier from the client device;
transmitting a request to an authentication server to determine whether payment information associated with the device identifier is stored, the request including the device identifier and information identifying the purchase request;
receiving a confirmation from the authentication server in response to the authentication server determining that the authentication server has stored payment information associated with the device identifier and that the stored payment information associated with the device identifier has been authenticated;
transmitting a payment confirmation and the purchase request to the provider in response to receiving the confirmation from the authentication server; and
transmitting a purchase confirmation to the client device in response to receiving the confirmation from the authentication server.

2. The method of claim 1, wherein the device identifier is an identifier stored on the client device, the identifier generated by an application associated with the payment system and executing on the client device.

3. The method of claim 1, wherein the provider comprises a vendor associated with a venue.

4. The method of claim 3, wherein the request transmitted to the authentication server includes information identifying the vendor.

5. The method of claim 4, wherein receiving the confirmation from the authentication server in response to the authentication server determining that the authentication server has stored payment information associated with the device identifier and that the stored payment information associated with the device identifier has been authenticated comprises:
receiving a confirmation from the authentication server in response to the authentication server determining that the authentication server and associated with the information identifying the vendor and determining that the stored payment information associated with the device identifier has been authenticated.

6. The method of claim 1, further comprising:
receiving a notification from the authentication server in response to the authentication server determining that the authentication server does not have stored payment information associated with the device identifier; and
transmitting a request for payment information to the client device.

7. The method of claim 6, further comprising:
receiving encrypted payment information from the client device in association with the device identifier of the client device; and
transmitting the encrypted payment information in association with the device identifier to the authentication server for storage.

8. The method of claim 6, wherein the request comprises a form.

9. A computer program product for providing payment services, the computer program product comprising a computer-readable storage medium containing computer program code for:
receive, from an application executing on a client device, a purchase request to purchase a product or a service from a provider;
obtain a device identifier from the client device;
transmit a request to an authentication server to determine whether payment information associated with the device identifier is stored, the request including the device identifier and information identifying the purchase request;
receive a confirmation from the authentication server in response to the authentication server determining that the authentication server has stored payment information associated with the device identifier and that the stored payment information associated with the device identifier has been authenticated;
transmit a payment confirmation and the purchase request to the provider in response to receiving the confirmation from the authentication server; and
transmit a purchase confirmation to the client device in response to receiving the confirmation from the authentication server.

10. The computer program product of claim 9, wherein the device identifier is an identifier stored on the client device, the identifier generated by an application associated with the payment system and executing on the client device.

11. The computer program product of claim 9, wherein the provider comprises a vendor associated with a venue.

12. The computer program product of claim 11, wherein the request transmitted to the authentication server includes information identifying the vendor.

13. The computer program product of claim 12, wherein receive the confirmation from the authentication server in response to the authentication server determining that the authentication server has stored payment information associated with the device identifier and that the stored payment information associated with the device identifier has been authenticated comprises:
receive a confirmation from the authentication server in response to the authentication server determining that the authentication server and associated with the information identifying the vendor and determining that the stored payment information associated with the device identifier has been authenticated.

14. The computer program product of claim 9, wherein the computer-readable storage medium further has instructions encoded thereon that, when executed by the processor, cause the processor to:
receive a notification from the authentication server in response to the authentication server determining that the authentication server does not have stored payment information associated with the device identifier; and
transmit a request for payment information to the client device.

15. The computer program product of claim 14, wherein the computer-readable storage medium further has instructions encoded thereon that, when executed by the processor, cause the processor to:
receive encrypted payment information from the client device in association with the device identifier of the client device; and
transmit the encrypted payment information in association with the device identifier to the authentication server for storage.

16. The computer program product of claim 14, wherein the request comprises a form.

17. The computer program product of claim 9, wherein the computer-readable storage medium further has instructions encoded thereon that, when executed by the processor, cause the processor to:
receive a notification from the authentication server in response to the authentication server determining that stored payment information associated with the device identifier by the authentication server has not been authenticated; and
transmit a request for payment information to the client device.
